(19) United States
(12) Patent Application Publication
(10) Pub. No.: US 2004/0101755 A1
(43) Pub. Date: May 27, 2004

(54) Electrochemical element and process for its production

(76) Inventors: Hong Huang, BL Delft (NL); Erik Maria Kelder, Delft (NL); Franciscus Guntherus Bernardus Ooms, Delft (NL); Daniel Russell Simon, Delft (NL)

Correspondence Address: Richard F Lemuth, Shell Oil Company, Intellectual Property, PO Box 2463, Houston, TX, 77252-2463, US

(21) Appl. No.: 10/333,890

(22) PCT Filed: Jul. 17, 2001
(86) PCT No.: PCT/EP01/08284

(51) Int. Cl. H01M 4/48; H01M 4/50

(52) U.S. Cl. 429/231.1; 429/231.5; 429/224

(57) ABSTRACT

An electrochemical element (1) suitable for use at high (>55° C.) temperatures comprises an electrolyte (4), an anode (3), a cathode (6), and current collectors for the anode and the cathode, wherein the anode (3) comprises as a host material for alkali metal ions a spinel type material which is an alkali metal titanium oxide, preferably in the form of a nano-powder and the current collector of the anode (3) is an aluminium metal based current collector.

### FIELD OF THE INVENTION

This invention relates to an electrochemical element, which comprises an electrolyte, an anode, a cathode and current collectors for the anode and the cathode, wherein the anode comprises as a host material for alkali metal ions. The invention also relates to a process for producing such an electrochemical element and components thereof.

### BACKGROUND OF THE INVENTION

Insertion compounds have widely been used in electrochemical elements as a host material of the electrodes. Examples of such insertion compounds are carbons and spinels of an alkali metal and a transition metal oxide. For example, conventional lithium batteries may be based, as the cathode material, on a spinel of which the alkali metal is lithium and, as the anode material, on carbon. During the charge of the electrochemical element alkali metal ions are extracted from the host material of the cathode into the electrolyte and alkali metal ions are inserted from the electrolyte into the host material of the anode. The reverse processes take place during discharging the electrochemical element.

The content of alkali metal of the spinel varies during the charge/discharge cycle, and it frequently deviates from the formal stoichiometry of the original spinel, i.e. the spinel, which was used in the manufacture of the electrochemical element. In this patent document, unless indicated otherwise, the term “spinel type material” embraces the spinel in question itself and the materials, which can be formed from the spinel by electrochemical extraction/insertion of alkali metal ion such as during a charge/discharge cycle.

Electrochemical elements also comprise metal based current collectors which are in contact with the electrodes and which connect the electrodes with the electrical circuitry which is powered by the electrochemical element during its discharge or from which the electrical element receives power during its charge.

Many commercial operations take place under harsh conditions, such as at temperatures substantially above room temperature. Such high temperature operations take place, for example, inside processing equipment used in the chemical industry, and in down hole locations in the exploration and production of gas and oil. In such operations measuring and control devices may be used which need a source of electrical energy.

The electrochemical elements applied in commercial operations need to be composed of materials which—as such and in combination—withstand the conditions under which they are employed, preferably for a long period of time. For this reason, the anode current collectors are frequently made of stainless steel, nickel or copper, in particular when used in combination with a carbon-based anode. Namely, stainless steel, nickel and copper current collectors withstand harsh conditions, where e.g. an aluminium current collector is sensitive to corrosion, in particular in combination with a carbon based anode.

EP-A-470492 discloses a nickel or stainless steel anode current collector used in combination with a carbon-based anode. EP-A-989622 discloses the use of a copper anode current collector in combination with an anode, which comprises a Li₄Ti₅O₁₂ spinel type material.

Because stainless steel, nickel and copper are relatively high in density, these metals contribute significantly to the weight of the electrochemical element and they cause that the electrochemical element has a relatively low power density on a weight basis. Further, stainless steel, nickel and copper are relatively expensive metals. The use of nickel and copper in electrochemical elements is also disadvantageous in view of environmental concerns.

It has now unexpectedly been found that an aluminium based current collector can be used in combination with an anode which comprises as the host material for alkali metal ions a spinel type material which is an alkali metal titanium oxide, without or with a greatly reduced danger of corrosion when the electrochemical element is used in commercial, long duration operations, in particular at a relatively high temperature. Further, the use of aluminium takes away or reduces the disadvantages seen with the stainless steel, nickel and copper based anion current collectors.

D Peramunage et al., J. Electrochem. Soc., 145 (1998) pp. 2609-2615, presents an evaluation of Li₄Ti₅O₁₂ spinel as a host material of an electrochemical element. In the tests carried out, test model electrochemical elements were applied which comprise a single layer anode/electrolyte/cathode composite with the electrode materials coated on an aluminium foil. The present invention is unexpected in view of this reference because in this reference there is no disclosure or a suggestion to employ in electrochemical elements suitable for use under practical, i.e. other than in the applied test model, an aluminium based current collector in combination with an alkali metal titanium oxide based anode. Further, there is nothing in this reference which would teach the skilled person that this particular combination of an alkali metal titanium oxide based anode and an aluminium based anode current collector could be used without a danger of corrosion or with a greatly reduced danger of corrosion.

### SUMMARY OF THE INVENTION

Accordingly, the present invention provides an electrochemical element which comprises an electrolyte, an anode, a cathode, and current collectors for the anode and the cathode, wherein the anode comprises as a host material for alkali metal ions a spinel type material which is an alkali metal titanium oxide and wherein the current collector of the anode is an aluminium metal based current collector.

In more detail, the test model electrochemical elements applied by D Peramunage et al., referred to hereinbefore, consist of a single layer of an aluminium/anode/electrolyte/cathode/aluminium composite and a hermetically sealed evacuated metallized plastic envelope, which composite is positioned in the said envelope and of which composite

the anode layer comprises a composition consisting of 87.5% w of Li₄Ti₅O₁₂ spinel, 10% w of carbon having an surface area of 80 m²/g and 2.5% w of polyacrylonitril, and comprises further ethylene carbonate, propylene carbonate and LiPF₆, and has a thickness of 0.025 mm and a surface area of 10 cm², or a thickness of 0.030 mm and a surface area of 11.3 cm²;

the electrolyte layer comprises polyacrylonitril having a molecular weight of 105 and LiPF₆, and has a thickness of 0.088 mm;

the anode layer comprises a composition of 85.0% w of LiMn₂O₄ spinel, 10% w of the said carbon having a surface area of 80 m²/g, 2.5% w of poly(vinylidine fluoride) and 2.5% w of polyacrylonitril, and comprises further ethylene carbonate, propylene carbonate and LiAsF₆, and has a thickness of 0.045 mm and a surface area of 10 cm²; and

the aluminium layers have a thickness of 0.023 mm (0.9 mil).

Electrochemical elements so defined are excluded from the protection sought for the present invention.

### DETAILED DESCRIPTION OF THE INVENTION

The spinel type materials and also some of the further materials described hereinafter comprise an alkali metal. In such cases the alkali metal may be for example sodium or lithium. It is preferred that the alkali metal is lithium. Typically, these materials comprise the same alkali metals and typically they comprise a single alkali metal. It is most preferred that these materials comprise lithium as the single alkali metal. Thus, the electrochemically active alkali metal, i.e. the alkali metal A as defined hereinafter, is preferably solely lithium.

The electrochemical element comprises, as electrodes, a cathode and an anode, and it further comprises an electrolyte. The anode comprises a host material, which has a lower electrochemical potential relative to the alkali metal than the host material of the cathode. The difference in the electrochemical potential relative to the alkali metal, measured at 25° C., is typically at least 0.1 V and it is typically at most 10 V. Preferably this difference is in the range of from 0.2 to 8 V.

The cathode, the electrolyte and the anode, independently, may comprise a homogeneous material, or they may comprise a heterogeneous material. The heterogeneous material comprises frequently a particulate material embedded in a binder. It is preferred that the host materials of the cathode and/or the anode are present as particulate materials embedded in a binder. The binder may also be present as a layer between the electrodes, binding the electrodes together, in which case the binder has the function of the electrolyte.

U.S. Pat. Nos. 5,518,842, 5,698,338, WO-97/10620 and EP-A-470492 and the references cited in these documents disclose suitable materials for use in the electrodes and the electrolyte, and relevant methods for making electrochemical elements. Also reference may be made, for materials and for methods, to D Linden (Ed.), “Handbook of batteries”, 2^{nd} Edition, McGraw-Hill, Inc., 1995.

In order to have more practical value, it is desirable that the materials for making the electrodes and the electrolyte are selected such that—as such and in combination—they sustain to a sufficient degree the conditions at which the electrochemical element is used, such as the temperature, the time and the applicable charging voltage, thus preventing the electrochemical element from degradation and capacity fading during cycling.

Typically the electrochemical element comprises a solid inorganic material as a binder, for example a ceramic or, preferably, a glass. The glass may be a silicon, an aluminium or a phosphorus based glass, and it may be an oxide or an sulphide based glass. Mixed forms of two or more of such glasses are also possible. Alternatively, the electrochemical element comprises a polymer as a binder, for example polyacrylonitril or polyvinylidenedifluoride.

Most preferably, the electrochemical element is a solid-state element, i.e. an electrochemical element which employs solid electrodes and a solid electrolyte, and no liquids are present. The use of a glass as a binder obviates the presence of liquid. The presence of liquid in the electrochemical elements is conventional, but disadvantageous in view of leakage during use and other forms of instability of the electrochemical element, especially at high temperature.

By the addition of a suitable conductive filler, a non-conductive binder may be made conductive for alkali metal ions, or the non-conductive binder may be made conductive for electrons. Alternatively, a binder may be chosen which in itself is conductive. The binder may or may not comprise an inert filler, such as alumina, silica or boron phosphate. A binder, which is conductive for alkali metal ions may be used as a constituent of a cathode, an electrolyte or an anode, and a binder which is conductive for electrons may be used as a constituent of a cathode or an anode. The electrolyte may suitable be made of the material of the binder itself, without a particulate material embedded therein, provided that the binder is conductive for alkali metal ions.

The glass is suitably a non-conductive glass or a glass, which is conductive for alkali metal ions.

A non-conductive glass is for example a borosilicate glass or a boron phosphorus silicate glass.

The glass, which is conductive for the alkali metal ions may suitably be selected from glasses which are obtainable by combining an alkali metal oxide, boron oxide and phosphorus pentoxide. Particularly useful are glasses of this kind which are of the general formula A₃ₓB₁₋ₓPO₄, in which general formula A represents an alkali metal and x may have any value from ⅛ to ⅔, in particular ⅗. These glasses may be obtained by heating a mixture of the ingredients above 150° C., preferably 400-600° C.

Alternatively, the glass which is conductive for alkali metal ions may suitable be selected from glasses which are similarly obtainable by combining an alkali metal sulphide, an alkali metal halogen and boron sulphide and/or phosphorus sulphide, such as disclosed in J L Souquet, “Solid State Electrochemistry”, P G Bruce (Ed.), Cambridge University Press, 1995, pp. 74, 75. Preferably, the glass is obtainable by combining an alkali metal sulphide and phosphorus sulphide. Most preferably, the glass is of the formula P₂S₅.2Li₂S.

Other suitable glasses which are conductive for the alkali metal ions are of the general formulae A₄SiO₄ and A₃PO₄, in which general formulae A represents an alkali metal.

For increasing the conductivity for alkali metal ions the binder may comprise a particulate material, which is conductive for the alkali metal ions. Such a particulate material may suitably be selected from

alkali metal salts, such as halogenides, perchlorates, sulphates, phosphates and tetrafluoroborates,

alkali metal aluminium titanium phosphates, for example Li_{1.3}Al_{0.3}Ti_{1.7}(PO₄)₃, and

any of the glasses which are conductive for alkali metal ions as described hereinbefore.

For increasing the conductivity for electrons, the binder may comprise a particulate material, which is conductive for electrons. Such a particulate material may suitably be selected from carbon particles and metal particles, for example particles of copper or, preferably, aluminium.

In a preferred embodiment of the invention the electrical conductivity of the electrochemical element is increased by the presence in one or both electrodes and/or in the electrolyte of a small quantity of a low molecular weight polar organic compound. The quantity is preferably so small that the organic compound does not form a separate liquid phase and that the electrochemical element is a solid-state electrochemical element.

Suitable low molecular weight polar organic compound have up to 8 carbon atoms. Examples of such compounds are carbonates, amides, esters, ethers, alcohols, sulphoxides and sulphones, such as ethylene carbonate, dimethyl carbonate, N,N-dimethylformamide, gammabutyrolactone, tetraethyleneglycol, triethyleneglycol dimethyl ether, dimethylsulphoxide, sulpholane and dioxolane.

Now turning more in particular to the host materials of the electrodes, the electrochemical element comprises an anode comprising, as a host material for alkali metal ions, a spinel type material which is an alkali metal titanium oxide and it further comprises a cathode comprising a host material for the said alkali metal ions which differs from the host material of the anode by having a higher electrochemical potential relative to the alkali metal.

The alkali metal titanium oxide based spinel type material is preferably of the general formula A_{1+d+q}MₓTi_{2-d}O₄, wherein A denotes an alkali metal, M denotes a transition metal ion Cr, Fe, or Mn, d may have any value from 0 to ⅓, and x may have a value from 0 to 1. In a first preferred embodiment, d is between 0 and ⅓, such as from 1/10 to ⅓, in particular d is ⅓, x is 0, and q is a running parameter which typically can have any value from 0 to 5/3, preferably from 0 to 1. In a second preferred embodiment, d is 0, and x is between 0.5 and 1.5 such as from 0.9 to 1.1, in particular x is 1, and q is a running parameter which typically can have any value from 0 to 1.5, preferably from 0 to 1.

As indicated hereinbefore, the alkali metal ions derived from the alkali metal A can be extracted from or inserted into a spinel type material. As a consequence, the value of the running parameter q changes in accordance with the state of charge/discharge of the electrochemical element. For the manufacture of the electrochemical element the corresponding spinel itself is preferably used. For example, the anode of the electrochemical element may be based on a spinel of the general formula A_{1+d}Ti_{2-d}O₄, in particular A_{4/3}Ti_{5/3}O₄, wherein A denotes an alkali metal, which may also be designated by the general formula A₄Ti₅O₁₂. Reference may be made to Zezhau-Christiansen, “Lithium insertion in oxide spinels”, in Solid State Ionics, Vol. 40-41 (1990), pp. 580-584.

Host materials of the cathode may be selected from a wide range. For example, they may be based on one or more spinels of the general formulae ACoO₂, ANiO₂, AV₂O₅ and in particular AMn₂O₄, wherein A denotes an alkali metal. Mixed forms of such spinel materials are also possible, for example ACo_{1/2}Ni_{1/2}O₂.

Host materials of the cathode which are in particular suitable for use at a high temperature may be selected from spinel type materials of the general formula A_{q}M′_{z}M′_{1+x-z}Mn₁₋ₓO₄, in which general formula M″ represents a metal which is selected from the metals of the Periodic Table of the Elements having an atomic number from 22 (titanium) to 29 (copper), and may also be manganese, and M′ represents an alkaline earth metal or zinc, x can have any value from −1 to 1, on the understanding that if the spinel type material comprises an alkaline earth metal or zinc, the atomic ratio of the total of alkaline earth metal and zinc to the total of other metals M″ and manganese is at most ⅓, and q is a running parameter which typically can have any value from 0 to 1. Preferably, M″ represents a metal, which is selected from the metals having an atomic number from 23 (vanadium) to 29 (copper), in particular chromium or nickel, and M′ represents an alkaline earth metal or zinc, in particular magnesium or zinc. The value of x may be for example −1, 0 or 1, and the value of z may be for example 0.2, 0.1 or 0. Preferably x is in the range of from −1 to less than 1, such as from −1 to 0.9, in particular from −0.9 to 0.9, and z is in the range from 0 to 0.5. In a more preferred embodiment x is in the range of from −0.5 to 0.5, and z is in the range from 0 to 0.2, in particular x is in the range of from −0.2 to 0.2, and in particular z is in the range from 0.05 to 0.15. Examples of the spinel type materials of the general formula A_{q}M′_{z}M″_{1+x-z}Mn₁₋ₓO₄ are Li_{q}Ni_{0.5}Mn_{1.5}O₄, Li_{q}Cr₂O₄, Li_{q}CrMnO₄, Li_{q}Cr_{0.2}Mn_{1.8}O₄, Li_{q}Ti₂O₄, Li_{q}Mn₂O₄, Li_{q}FeMnO₄, Li_{q}Mg_{0.5}Mn_{1.5}O₄, Li_{q}Zn_{0.1}Mn_{1.9}O₄, Li_{q}Mg_{0.1}Ni_{0.4}Mn_{1.5}O₄. The corresponding spinels of the general formula A_{q}M′zM″_{1+x-z}Mn₁₋ₓO₄ (i.e. q equals 1) are preferably used in the manufacture of the cathode.

Alternative host materials of the cathode, which are in particular suitable for use at a high temperature may be selected from inverse spinel type materials.

The term “inverse spinel” may be explained as follows. The spinels which are frequently used in electrochemical elements have a crystal structure in which the oxygen atoms are placed in a face centered cubic arrangement within which the transition metal atoms occupy the 16d octahedral sites and the alkali metal atoms occupy the 8a tetrahedral sites. Spinels in which alkali metal atoms occupy 16d octahedral sites, instead of 8a tetrahedral sites, and transition metal atoms occupy 8a tetrahedral sites, instead of 16d octahedral sites, are frequently indicated by the term “inverse spinel”. Inverse spinels can be distinguished from the normal spinels by their X-ray diffraction patterns and/or their neutron diffraction patterns.

In this patent document the commonly known, standard Wyckoff nomenclature/notation is used in respect of the crystal structure of spinel type materials. Reference may be made to “The International Tables for X-ray Crystallography”, Vol. I, The Kynoch Press, 1969, and to the JCPDC data files given therein.

The inverse spinel type material is typically selected such that at least 25% of the sites available for hosting alkali metal ions are 16d octahedral sites. Preferably at least 50%, more preferably at least 90%, most preferably at least 95% of the sites available for hosting alkali metal ions are 16d octahedral sites. In particular, all sites available for hosting alkali metal ions are 16d octahedral sites. This does not exclude that in the inverse spinel type materials another element, in addition to the alkali metal, occupies a portion of the 16d octahedral sites.

Suitable inverse spinel type materials are of the general formula A_{q}Ni_{1-a-b}CoₐCu_{b}VO₄, wherein A represents an alkali metal, a and b can have any value from 0 to 1, on the understanding that a +b is at most 1, and q is a running parameter which typically can have any value from 0 to 1. Such inverse spinel type materials are known from U.S. Pat. Nos. 5,518,842, 5,698,338, G T K Fey et al., Journal of Power Sources, 68 (1997), pp. 159-165. Preferred inverse spinel type materials are for example Li_{q}NiVO₄, Li_{q}Ni_{0.5}Co_{0.5}VO₄, Li_{q}CoVO₄, and Li_{q}CuVO₄ in which general formulae q has the meaning as given hereinbefore. The corresponding spinels of the general formula A_{q}Ni_{1-a-b}CoₐCu_{b}VO₄ (i.e. q equals 1) are preferably used in the manufacture of the cathode.

The spinel type materials of the general formula A_{q}M′_{z}M″_{1+x-z}Mn₁₋ₓO₄ as defined hereinbefore, and the inverse spinel type materials are preferably used as the cathode material because of their relatively high electrochemical potential and because electrochemical elements which are based on such spinel materials as host material of the cathode can be subjected to a plurality of charge/discharge cycles at a high temperature, with a good performance as regards the capacities delivered and maintained during the various charge/discharge cycles.

The anode and the cathode may comprise independently

typically at least 30% w and typically up to 99.5% w, preferably from 40 to 70% w of the host material;

typically at least 0.1% w and typically up to 20% w, preferably from 2 to 15% w of the particulate material which increases the conductivity for electrons;

typically at least 0.2% w and typically up to 50% w, preferably from 5 to 40% w of the particulate material which increases the conductivity for alkali metal ions; and

typically at least 0.1% w and typically up to 20% w, preferably from 2 to 15% w of binder in which particulate materials may be embedded.

If no particulate material, which increases the conductivity for alkali metal ions is present, the binder may be present in a quantity typically of at least 0.1% w and typically up to 70% w, preferably from 2 to 55% w. The quantities defined in this paragraph are relative to the total weight of each of the anode and the cathode, respectively.

The electrolyte may comprise

typically at least 70% w and typically up to 99.5% w, preferably from 75 to 99% w of the particulate material which increases the conductivity for alkali metal ions; and

typically at least 0.1% w and typically up to 30% w, preferably from 1 to 25% w of binder in which a particulate material may be embedded.

The quantities defined in this paragraph are relative to the total weight of the electrolyte.

A preferred anode comprises, based on the total weight of the anode, 50% w of particles of a spinel type material of the general formula A_{1+d+q}MₓTi_{2-d}O₄, in which general formula q is a running parameter which typically can have any value from 0 to 1, and 10% w of graphite powder, imbedded in 40% w of a binder which is a glass of the general formula Li₃ₓB₁₋ₓPO₄ wherein x is 0.6.

A preferred cathode comprises, based on the total weight of the cathode, 50% w of particles of an inverse spinel type material of the general formula Li_{q}NiVO₄, in which general formula q is a running parameter which typically can have any value from 0 to 1, or a spinel type material of the general formulae Li_{q}Ni_{0.5}Mn_{1.5}O₄, Li_{q}Cr_{0.2}Mn_{1.8}O₄, or Li_{q}Mg_{0.1}Ni_{0.4}Mn_{1.5}O₄, in which general formulae q is a running parameter which typically can have any value from 0 to 1, 10% w of graphite powder, imbedded in 40% w of a binder which is a glass of the general formula Li₃ₓB₁₋ₓPO₄ wherein x is 0.6.

A preferred electrolyte comprises, based on the total weight of the electrolyte, 80% w of Li₄SiO₄ particles imbedded in 20% w of a binder which is a glass of the general formula Li₃ₓB₁₋ₓPO₄ wherein x is 0.6.

The electrochemical element comprises preferably a preferred anode, a preferred cathode and a preferred electrolyte as defined in the previous three paragraphs.

The electrodes and the electrolyte are preferably present in the electrochemical element in the form of layers, which means that one dimension (i.e. the thickness) is considerably smaller than the other dimensions, so as to form a relatively large surface area. Suitably, the layers are in the form of a foil or a disk. Such layers can be made by mixing the ingredients and subsequently shaping the mixture into the desired shape, for example by doctor blading, tape casting, compression moulding, or preferably extrusion or co-extrusion. The skilled person is aware of such techniques.

The thickness of the anode and cathode layers may be chosen between wide limits and independently from each other. For example, the thickness of the electrode layers may be less than 2 mm and it may be at least 0.001 mm. Preferably the thickness of the electrode layers is the range of from 0.01 to 1 mm. The thickness of the electrolyte layer may be less than 0.02 mm and it may be at least 0.0001 mm. Preferably the thickness of the electrolyte layers is the range of from 0.001 to 0.01 mm. An advantage of using a glass as a binder is that it allows that thin layers can be made, yet of considerable mechanical strength.

The layers may be combined in the order of anode/electrolyte/cathode to form composite layers. The electrochemical element may comprise a plurality of such composite layers. Preferably, for reasons of ease of construction and/or economy of space, the composite layers may overlap with each other. They may be stacked. The number of the composite layers in a stack may be chosen between wide limits, for example up to 10 or 15, or even more. Alternatively, one or more composite layers may be wound, to form a cylindrical body.

The total surface area of composite layer is suitably at least 15 cm². In this patent document the surface area of a layer is defined as the surface area of one of the opposite main surfaces of the layer. Frequently, for practical reasons, the total surface area is at most 10 m². Typically the total surface area is in the range of from 100 cm² to 2.5 m². For some applications it is desirable to apply in the electrochemical elements composite layers which have a small total surface area, for example in electrochemical elements which are intended to be used in miniaturized electronic equipment. In such cases—when a single composite layer is present in the electrochemical element—the total surface area is typically less than 8 cm² and it is typically larger than 0.1 mm², for example, in the range of from 1 mm² to 5 cm². In such cases—when a two or more composite layer are present in the electrochemical element or one or more composite layers are wound to form a cylindrical body—the total surface area is typically less than 15 cm² and it is typically larger than 0.1 mm², for example, in the range of from 1 mm² to 10 cm².

Each current collector is in contact with an electrode. The current collectors are not necessarily made of the same metal and they may be present in different forms. The current collectors are preferably present as a layer in the form of a foil or disk, in accordance with the form of the electrodes and the electrolyte. The layers of the current collectors may be closed, i.e. without holes, or open, such as in the form of a grid. For example, a current collector may be present as a separate closed or open layer adjacent and in direct contact with an electrode layer or it may be present as a grid imbedded in an electrode.

The thickness of the current collector layers may be chosen between wide limits. For example, the thickness may be less than 1 mm and at least 0.001 mm, preferably in the range of 0.01 to 0.1 mm.

In accordance with this invention, at least one anode current collector is aluminium metal based. If a plurality of anode current collectors is present, it is preferred that all anode current collectors are aluminium metal based. The aluminium metal may be an alloy, i.e. comprising further metals, such as magnesium, silicon, zinc, and less preferably manganese, chromium, zirconium, and titanium. Preferably the content of aluminium is at least 50% w, in particular at least 80% w, more in particular at least 90% w, based on the weight of the aluminium alloy. For reasons of practicability, the content of aluminium is most 99.99% w, in particular at most 99.9% w, more in particular at most 99% w.

The metal selected for the cathode current collector is not material to the invention. For example, the cathode current collector may be copper, stainless steel, or nickel based. However, it is preferred that the cathode current collector is aluminium based and, in particular, of the same aluminium metal as the anode current collector.

The electrodes, the electrolyte and the current collectors may be arranged such as to form a parallel or a series arrangement of separate electrochemical elements. If necessary, additional electrolyte and/or electrically insulating means may be added in order to accomplish such an arrangement in an economic way.

The electrically insulating means are preferably in the form of a layer, such as a foil or a disk, in accordance with the form of the anode, the electrolyte and the cathode. The thickness of the electrically insulating layers may be chosen between wide limits. For example, the thickness may be less than 1 mm and at least 0.0001 mm, preferably in the range of 0.001 to 0.1 mm.

The electrically insulating means may be made of any insulating material, which is suitable in view of the conditions of use of the electrochemical element in accordance with this invention. The electrically insulating means is preferably made of a non-conductive glass, as described hereinbefore. Alternatively, the insulating means may be made of a polyimide, for example a polyimide, which can be obtained under the trademark KAPTON.

Preferably the electrochemical element is manufactured by dynamic compaction of the electrodes, the electrolyte, the current collectors and any additional component, if present, suitably arranged as described hereinbefore. The technique of dynamic compaction is known from, inter alia, WO-97/10620 and the references cited therein. Dynamic compaction uses a pressure pulse, which results in a pressure wave travelling through the object to be compacted. The pressure pulse may be generated by an explosion using explosives, by an explosion via a gas gun or by magnetic pulses. Dynamic compaction leads to improved interfacial contact between the components and between particulate materials and their surrounding binder. Therefore, dynamic compaction yields electrochemical elements, which have a relatively low internal electrical resistance.

As part of the production process it may be needed to extract or insert alkali metal from or into one or more of the spinel type materials. This can be done during the first charging of the electrochemical element. This can also be done separately by electrochemical methods or by methods with acid, such as disclosed in U.S. Pat. No. 4,312,930. The further construction of the electrochemical elements of this invention is preferably such that they can withstand high temperatures, high pressures and mechanical shocks.

The skilled person is aware of methods, which he can apply for charging and any conditioning, if needed, of the electrochemical element.

According to this invention electrochemical elements may be made of a wide range of capacities. In this patent document the capacity is defined for quantitative purposes as the nominal capacity of the element measured at 25° C., at 100% depth of discharge and at a discharge time of 10 hours. For demanding application the nominal capacity of the electrochemical element may be at least 25 mWh and it is typically at most 10 kWh. Preferably, the nominal capacity is in the range of from 100 mWh to 2 kWh.

The electrochemical element in accordance with the invention can be subjected to a plurality of charge/discharge cycles, in particular at a high temperature, exhibiting a good performance as regards the capacities delivered and maintained during the various charge/discharge cycles. The electrochemical element is preferably used at a temperature of at least 40° C., in particular at least 55° C. In most instances the electrochemical element may be used at a temperature of at most 300° C. The electrochemical element is in particular used at a temperature between 65° C. and 250° C. The electrochemical element performs well under conditions of high rates of charge and discharge. The electrochemical element is especially suitable for use inside processing equipment of chemical and oil processing plants, and in down hole locations in the exploration and production of gas and oil. The electrochemical element is typically a rechargeable battery.

It may be advantageous to produce the electrochemical element in a form such that it can be used as a constructional element of a larger entity. Thus, the electrochemical element may be made in the form of a pipe, or in the form of a container or a part of a container, which is designed to hold electronic equipment.

It is also advantageous that the anode of the electrochemical element according to the invention comprises, as a host material for alkali metal ions, a spinel type material which is based on an alkali metal titanium oxide spinel in the form of a nano-powder, in particular a nano-powder of which the particles have a size in the range of 2 to 500 nm, more in particular in the range from 3 to 200 nm.

As described hereinbefore a spinel of alkali metal titanium oxide is known in the art for use in electrochemical elements, cf. D Peramunage et al., J. Electrochem. Soc., 145 (1998) pp. 2609-2615 and 2615-2622. This spinel can be made by heating a mixture of a titanium oxide and a source of alkali metal ions at a high temperature for a long period of time, cf. E Ferg et al. J. Electrochem. Soc., 141 (1994) pp. L147-L150, and R K B Gover, J. Electrochem. Soc., 146 (1999) pp. 4348-4353. For example, heating temperatures above 800° C., for example 1000° C., have been reported, in combination with a period of heating of up to 3 days. Thus, the preparation of the spinel is cumbersome, inefficient and costly, because of the drastic heating conditions required.

Further, it has been seen that during such a drastic heat treatment the solid particles present show a strong tendency to sintering. For example a fine powder will be transformed into a lumpy material that would need to be ground and sieved if the product is to be obtained in the form of a fine powder. For producing a high-power electrochemical element, it is desirable that the alkali metal titanium oxide spinel is in the form of a fine powder, preferably as a nano-powder.

It has now been found that the alkali metal titanium oxide spinel can conveniently be prepared at a substantially lower temperature, provided that initially and only for a relatively short period of time a high temperature is applied.

Therefore, the present invention also provides a process for preparing alkali metal titanium oxide spinels whereby substantially milder conditions are applied than in the known processes, with the associated advantages that the invented process is less cumbersome, more efficient and less costly. As a further advantage, by employing the milder conditions the tendency of the particles to sintering is much reduced, if not completely eliminated, so that the product spinels can be obtained directly in the form of a nano-powder, i.e. without further grinding and sieving.

Further, the alkali metal titanium oxide spinels prepared in accordance with this invention can advantageously be used as a high temperature electrode material, in particular in combination with a suitable binder, which is for example a glass to form a solid-state electrochemical element. The electrochemical element can be subjected to a plurality of charge/discharge cycles at a high temperature, with a good performance as regards the capacities delivered and maintained during the various charge/discharge cycles. The electrochemical element performs well at high rates of charge and discharge.

The invention provides a process for preparing an alkali metal titanium oxide spinel, which process comprises heating a mixture of a titanium oxide and a source of alkali metal ions at a first temperature of at least 600° C. for a period of at most 2 hours and subsequently heating at a second temperature which is at least 50° C. lower than the first temperature.

The titanium oxide (TiO₂) may be of any structure. The titanium oxide may be anatase type titanium oxide or rutile type titanium oxide, or mixed forms. In particular at least 50%, more in particular at least 90% of the titania is anatase type. Most preferably, the titania is exclusively anatase type.

The titanium oxide particles may be of any form and size. Preferred forms and sizes may be selected with a view on the application envisaged for the alkali metal titanium oxide spinel. If it is intended to prepare the alkali metal titanium oxide spinel in the form of a nano-powder, it is suitable to employ titanium oxide particles which are have a size of less than 1000 nm, in particular in the range of from 2 to 500 nm, more in particular of from 3 to 200 nm. The particle size as defined in this patent document is deemed to be the number average particle size as determined from a transmission electronic spectroscopy photograph by using the calculation method of the DIGITALMICROGRAPH 3 software package (trademark), supplied by Gatan, Inc., Pleasanton, Calif. 94588 (USA).

The titanium oxide is preferably a material, which has a large surface area. The surface area is typically at least 1 m²/g and typically at most 1000 m²/g. Preferably, the surface area is in the range of from 10 to 500 m²/g. The surface area as defined in this patent document is deemed to be based on BET surface area measurements according to ASTM D3663-92.

The nature of the source of alkali metal ions is not material to the invention. Suitable sources are for example, oxides, hydroxides and salts, such as carbonates, halogenides and carboxylates, for example acetates. The alkali metal is preferably lithium. Very suitable sources of alkali metal are lithium oxide, lithium hydroxide, lithium carbonate and lithium acetate.

The source of alkali metal ions is frequently a solid, whilst the form and size of the solid particles are not of any essence to the invention. If desirable, the source of alkali metal ions may be in the form of a liquid, for example as a solution in, e.g. water, or in the form of a melt. When applied in the form of a solution the solvent is suitably evaporated, prior to heating at the first temperature.

The ratio of the quantities of the titanium oxide and the source of alkali metal ions is also not material to the invention. Typically, the quantities are such that the atomic ratio of the alkali metal to the titanium is in the range of from 0.2 to 5, more typically from 0.4 to 1.5, in particular from 0.5 to 1.0. Preferably, the quantities are such as to satisfy the atomic ratio of the alkali metal to the titanium of a spinel of the general formula A_{1+d}Ti_{2-d}O₄, in which general formula A denotes the alkali metal, preferably lithium, and d may have any value from 0 to ⅓, preferably from above 0 to ⅓, such as from 1/10 to ⅓. More preferably, the quantities are such as to satisfy the atomic ratio of the alkali metal to the titanium of 0.8 of a spinel of the general formula A_{4/3}Ti_{5/3}O₄, in which general formula A denotes the alkali metal, preferably lithium. These spinels may also be designated by the general formula A₄Ti₅O₁₂.

The titanium oxide and the source of alkali metal ions may be mixed by any means. Preferably powders are mixed. The mixture may be made prior to the heating at the first temperature, or simultaneously with the heating at that temperature.

The process of this invention involves separate heating steps, by which the mixture is kept at different temperatures, the second temperature being lower than the first temperature. The first temperature is typically at least 700° C. and typically at most 1200° C. The first temperature is preferably in the range of from 750 to 1100° C., more preferably in the range of from 800 to 1000° C. The second temperature is typically at least 300° C. and typically at most 1000° C. The second temperature is preferably in the range of from 350 to 800° C., more preferably in the range of from 400 to 750° C. The first temperature and the second temperature are not necessarily kept constant, which means that during the heating steps the temperatures may be varied to some extent, for example within the ranges as indicated.

The period during which the mixture is heated at the first temperature is typically at least 1 minute and preferably in the range of from 5 minutes to 1.5 hour, more preferably in the range of from 15 minutes to 1 hour. The period during which the mixture is heated at the second temperature is not material to the invention. Generally, the period will be chosen sufficiently long as to bring the yield of the alkali metal titanium oxide spinel at the desired level. The period during which the mixture is heated at the second temperature is typically at least 1 hour and typically at most 30 hours. The period during which the mixture is heated at the second temperature is preferably in the range of from 1.5 to 20 hours, in particular of from 2 to 10 hours. The skilled person will appreciate that the periods during which the mixture is heated at the first temperature and at the second temperature may be chosen shorter as the temperatures are higher.

The heating may be effected in an inert atmosphere, but this is generally not needed. In some instances it may be desirable to apply an oxygen containing atmosphere, for example air, in particular when oxygen can assist in liberating alkali metal ions from the applied source of alkali metal ions. On the other hand, when a spinel is made of the general formula A_{1+d}Ti_{2-d}O₄, as defined hereinbefore, wherein d is different from ⅓, it is desirable to apply an atmosphere with a low oxygen partial pressure, preferably an inert atmosphere, which favours the formation of tri-valent titanium species.

After heating at the second temperature the mixture may be cooled. The obtained product as such may be employed in the envisaged application or, if desired, the obtained product may be purified, shaped or treated otherwise.

As indicated hereinbefore, the alkali metal titanium oxide spinel is preferably obtained in the form of a nano-powder. Suitably, the size of the particles of the nano-powder is at most 1000 nm, and the size of the particles is at least 1 nm. Preferably, the size is in the range of 2 to 500 nm, in particular in the range of from 3 to 200 nm.

The alkali metal titanium oxide spinel is preferably a material, which has a large surface area. The surface area is typically at least 1 m²/g and typically at most 1000 m²/g. Preferably, the surface area is in the range of from 10 to 500 m²/g.

The process for preparing the alkali metal titanium oxide spinel, which involves heating the mixture of the titanium oxide and the source of alkali metal ions is usually a solid state reaction. Without wishing to be bound by theory, it is believed that during the solid state reaction particles of the titanium oxide grow by the uptake of alkali metal ions.

### EXAMPLES

### Example 1

A titanium oxide powder having a particle size of 4 nm and a surface area of 380 m²/g (HOMBIKAT IF9425/11 (trademark), commercially available from Sachtleben) was mixed with lithium hydroxide dissolved in water. The atomic ratio of lithium over titanium was 0.8. The mixture was stirred for two hours. The water was evaporated. The residue was heated in air at 900° C. for 1 hour, subsequently at 650° C. for 15 hours and cooled to room temperature. X-ray diffraction analysis showed that the conversion of titanium oxide was complete.

### Example 2

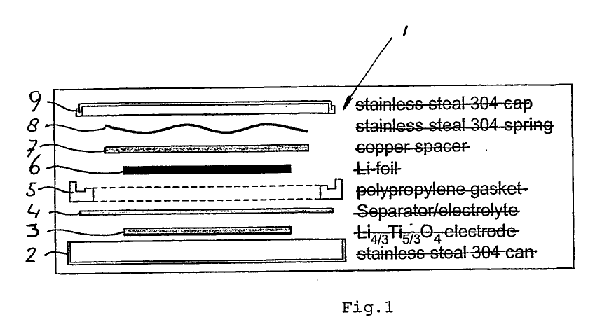

A coin-cell battery as shown in FIG. 1 was assembled and tested in the following manner.

All measurements were done using a CR2320 type coin-cell (Hohsen Corp.) of which a schematic cross-sectional view is depicted in FIG. 1. The coin-cell (1) was assembled in the following stacking order: a can (2), a ∅14 mm×21 mm Li_{4/3}Ti_{5/3}O₄ electrode (3), a ∅21 mm×20 μm separator/electrolyte foil (4), a polypropylene gasket (5), a ∅16 mm×0.5 mm Lithium foil (6), a ∅17 mm×0.5 mm copper spacer plate (7), ∅15 mm wave-spring (8) and cap (9). The can (1), spring (8) and cap (9) were made of stainless steel 304. The active mass in the electrode (3) of this electrochemical element was the 6.2 mg Li_{4/3}Ti_{5/3}O₄. The coin-cells were sealed in a Helium filled glovebox (H₂O<5 ppm).

The Li_{4/3}Ti_{5/3}O₄ material (3) (Hohsen Corp.) and the metallic lithium foil (6) were used as active electrode materials. The Li_{4/3}Ti_{5/3}O₄ electrode material (3) was fabricated via doctor-blade coating on a 10 μm thick aluminium current collector using a mixture of (a) the Li_{4/3}Ti_{5/3}O₄ material, (b) carbon-black (MMM SuperP), (c) graphite (Timrex SFG10) and (d) a binder PVDF (Solvay) dissolved in 1-methyl pyrrolidone (NMP) (Merck) in the mass ratio 80:3:7:10. The coating was quickly dried under vacuum at 140° C. for 15 minutes followed by drying under vacuum at 80° C. overnight. The resulting coatings were pressure rolled using a hand roller to a porosity of 40-50%. The liquid electrolyte used was 1 M LiPF₆ in EC/EMC 1:2. The material SOLUPOR (a trademark of DSM Solutech) was used as separator material (4).

Samples were cut from the Li_{4/3}Ti_{5/3}O₄ electrode coating (∅14 mm×21 mm), the lithium foil (∅16 mm×0.5 mm), and the separator material (∅21 mm×20 μm).

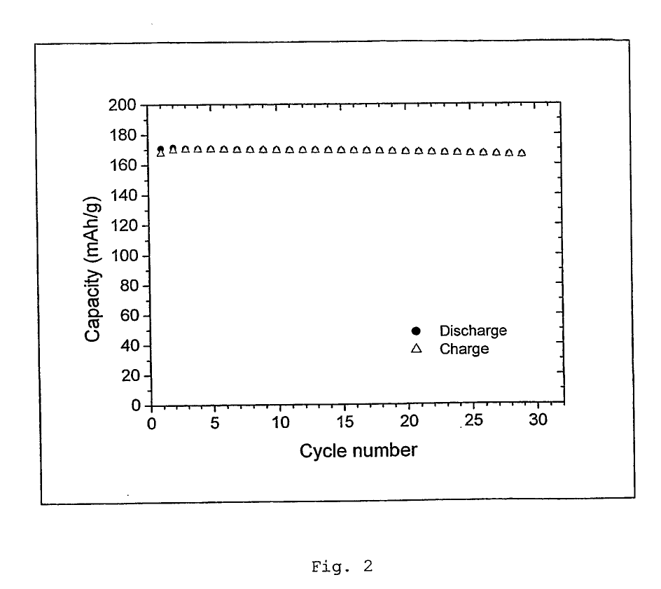

The thus assembled coin-cell (1) was tested in the following manner. During the measurements, the coin-cell was kept under pressure with a Hoffman clamp. The measurements were done with a Maccor S4000 battery tester using separate leads for current and voltage. The cell was thermostated at 60° C. in a climate chamber. The measurements comprised charging and discharging at a similar and constant rate of 1.0 mA, reflecting a 1 C (or one hour) charge and discharge rate. Cycling of the cell was done for over 25 cycles. Charging was done up to 2.6 Volt, whereas discharging was stopped at 0.8 Volt. The results of the measurements are shown in the diagram depicted in FIG. 2.

The combination of the Li_{4/3}Ti_{5/3}O₄ electrode and the metallic Lithium in this electrochemical element resulted in a battery with a voltage between 1.4 and 1.6 V. The measured charge and discharge capacities of the electrochemical element were between 1.0 and 1.1 mAh.

### Example 3

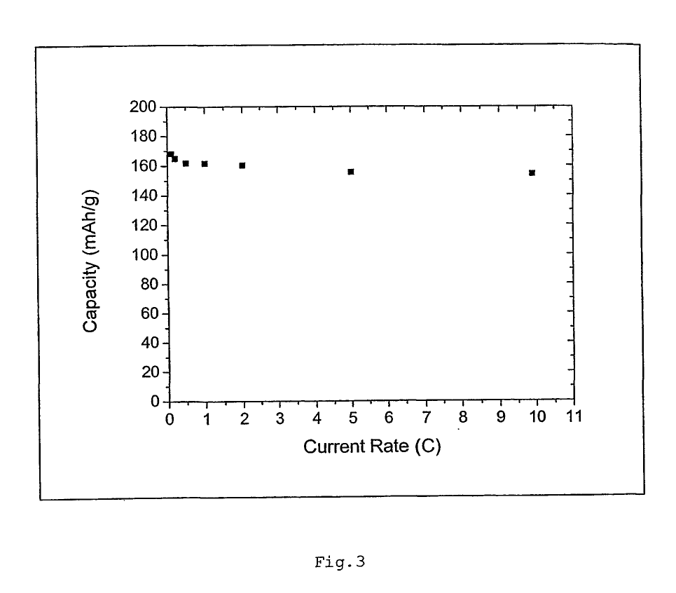

A coin-cell (1) comprising components which were stacked substantially in the same way as illustrated in FIG. 1 was assembled and tested. Li_{4/3}Ti_{5/3}O₄ material (3) (Hohsen Corp.) and metallic lithium (6) were used as active electrode materials. The Li_{4/3}Ti_{5/3}O₄ material was fabricated via doctor-blade coating on a 10 μm thick aluminium current collector using a mixture of (1) the Li_{4/3}Ti_{5/3}O₄ material, (2) carbon-black (MMM SuperP), (3) graphite (Timrex SFG10) and (4) a binder PVDF (Solvay) dissolved in 1-methyl pyrrolidone (NMP) (Merck) in the mass ratio 80:3:7:10. The coating was quickly dried under vacuum at 140° C. for 15 minutes followed by drying under vacuum at 80° C. overnight. The resulting coatings were pressure rolled using a hand roller to a porosity of 40-50%. The liquid electrolyte used was 1 M LiPF₆ in EC/EMC 1:2. Samples were cut from the Li_{4/3}Ti_{5/3}O₄ electrode coating (∅14 mm×21 mm), the lithium foil (∅16 mm×0.5 mm), and the separator material (∅21 mm×20 μm). All measurements were done using a CR2320 type coin-cell (Hohsen Corp.). The coin-cell was assembled in the following stacking order: can (2), ∅14 mm×21 mm Li_{4/3}Ti_{5/3}O₄ electrode (3), ∅21 mm×20 μm separator/electrolyte foil (4), polypropylene gasket (5), ∅16 mm×0.5 mm Lithium foil (6), spacer plate (7) (Cu ∅17 mm×0.5 mm), ∅15 mm wave-spring (8) and cap (9). The active mass in this electrochemical element was 6.2 mg of Li_{4/3}Ti_{5/3}O₄ electrode material (3). The coin-cell (1) was sealed in a Helium filled glovebox (H₂O<5 ppm). During the measurements, the coin-cell was kept under pressure with a Hoffman clamp. The measurements were done with a Maccor S4000 battery tester using separate leads for current and voltage. The cell was thermostated at 60° C. in a climate chamber. The measurements comprised charging at a constant current of 0.1 mA, reflecting a C/10 (or 10 hours) charge rate, where each subsequent charge was followed by a different discharge rate, with rates between 0.1 mA to 10 mA, reflecting discharge rates between C/10 and 10 C (between 10 hours and 6 minutes). The results of the measurements are illustrated in the diagram shown in FIG. 3. Charging was done up to 2.6 Volt, whereas discharging was stopped at 0.8 Volt. The combination of the Li_{4/3}Ti_{5/3}O₄ electrode and the metallic Lithium in this electrochemical element resulted in a battery with a voltage between 1.4 and 1.6 V. The measured charge and discharge capacities of the electrochemical element were between 1.0 and 1.1 mAh.

1. An electrochemical element which comprises an electrolyte, an anode, a cathode, and current collectors for the anode and the cathode, wherein the anode comprises as a host material for alkali metal ions a spinel type material which is an alkali metal titanium oxide and wherein the current collector of the anode is an aluminium metal based current collector, on the understanding that the electrochemical element is not an electrochemical element which consists of a single layer of an aluminum/anode/electrolyte/cathode/aluminum composite and a hermetically sealed evacuated metallized plastic envelope, which composite is positioned in the said envelope and of which composite
the anode layer comprises a composition consisting of 87.5% w of Li₄Ti₅O₁₂ spinel, 10% w of carbon having an surface area of 80 m²/g and 2.5% w of polyacrylonitril, and comprises further ethylene carbonate, propylene carbonate and LiPF₆, and has a thickness of 0.025 mm and a surface area of 10 cm², or a thickness of 0.030 mm and a surface area of 11.3 cm²;
the electrolyte layer comprises polyacrylonitril having a molecular weight of 105 and LiPF₆, and has a thickness of 0.088 mm;
the anode layer comprises a composition of 85.0% w of LiMn₂O₄ spinel, 10% w of the said carbon having an surface area of 80 m²/g, 2.5% w of poly(vinylidine fluoride) and 2.5% w of polyacrylonitril, and comprises further ethylene carbonate, propylene carbonate and LiAsF₆, and has a thickness of 0.045 mm and a surface area of 10 cm²; and
the aluminium layers have a thickness of 0.023 mm (0.9 mil).

2. An electrochemical element as claimed in claim 1, characterized in that the alkali metal titanium oxide based spinel type material is of the general formula A_{1+d+q}MₓTi_{2-d}O₄, wherein either A denotes an alkali metal, d may have any value from 0 to ⅓, x is 0, and q is a running parameter which can have any value from 0 to 5/3, or wherein A denotes an alkali metal, d is 0, M denotes Cr, x is 1, and q is a running parameter which typically can have any value from 0 to 1.

3. An electrochemical element as claimed in claim 2, characterized in that d is ⅓, x is 0, and q can have any value from 0 to 1.

4. An electrochemical element as claimed in claim 1, characterized in that the host material of the cathode is selected from
spinel type materials of the general formula A_{q}M′_{z}M″_{1+x-z}Mn₁₋ₓO₄, in which general formula M″ represents a metal which is selected from the metals of the Periodic Table of the Elements having an atomic number from 22 (titanium) to 29 (copper), and may also be manganese, and M′ represents an alkaline earth metal or zinc, x can have any value from −1 to 1, on the understanding that if the spinel type material comprises an alkaline earth metal or zinc, the atomic ratio of the total of alkaline earth metal and zinc to the total of other metals M″ and manganese is at most ⅓, and q is a running parameter which typically can have any value from 0 to 1, and
inverse spinel type materials of the general formula A_{q}Ni_{1-a-b}CoₐCu_{b}VO₄, wherein A represents an alkali metal, a and b can have any value from 0 to 1, on the understanding that a+b is at most 1, and q is a running parameter which typically can have any value from 0 to 1.

5. An electrochemical element as claimed in claim 1, characterized in that it comprises a glass as a binder.

6. An electrochemical element as claimed in claim 1, characterized in that the anode, the cathode and the electrolyte are present in the electrochemical element in the form of layers, which are combined in the order of anode/electrolyte/cathode to form one or more composite layers.

7. An electrochemical element as claimed in claim 6, characterized in that the composite layers have a total surface area of at least 15 cm² and at most 10 m², typically in the range of from 100 cm² to 2.5 m².

8. An electrochemical element as claimed in claim 1, characterized in that the aluminium metal comprises at least 80% w, in particular at least 90% w aluminium.

9. An electrochemical element as claimed in claim 1, characterized in that the cathode current collector is aluminium based.

10. An electrochemical element as claimed in any preceding claim, wherein the anode comprises, as a host material for alkali metal ions, a spinel-type material which is based on an alkali metal titanium oxide spinel in the form of a nano-powder, in particular a nano-powder of which the particles have a size in the range of 2 to 500 nm, more in particular in the range from 3 to 200 nm.

11. A process of manufacturing an electrochemical element as claimed in claim 6, which process comprises a step of dynamic compaction of the electrodes, the electrolyte, the current collectors and any additional component, if present.

12. A process for preparing an alkali metal titanium oxide spinel for use in an electrochemical element as claimed in any one of claims 1-10, which process comprises heating a mixture of a titanium oxide and a source of alkali metal ions at a first temperature of at least 600° C. for a period of at most 2 hours and subsequently heating at a second temperature which is at least 50° C. lower than the first temperature.

13. A process as claimed in claim 12, characterized in that the ratio of the quantities of the titanium oxide and the source of alkali metal ions are such as to satisfy the atomic ratio of the alkali metal to the titanium of a spinel of the general formula A_{1+d}Ti_{2-d}O₄, in which general formula A denotes the alkali metal, and d may have any value from 0 to ⅓, in particular ⅓.

14. A process as claimed in claim 12, characterized in that the alkali metal is lithium.

15. A process as claimed in claim 12, characterized in that the first temperature is preferably in the range of from 750 to 1100° C., in particular in the range of from 800 to 1000° C., and the second temperature is in the range of from 350 to 800° C., in particular in the range of from 400 to 750° C.

16. A process as claimed in claim 12, characterized in that the period during which the mixture is heated at the first temperature is in the range of from 5 minutes to 1.5 hour, in particular more in the range of from 15 minutes to 1 hour, and the period during which the mixture is heated at the second temperature is in the range of from 1.5 to 20 hours, in particular of from 2 to 10 hours.

17. The use of an electrochemical element as claimed in any one of claims 1-10 at a temperature of at least 40° C.

18. The use of an electrochemical element as claimed in any one of claims 1-10 at a temperature of at least 55° C.
